(19) United States
(12) Patent Application Publication
(10) Pub. No.: US 2010/0239731 A1
(43) Pub. Date: Sep. 23, 2010

(54) Method of producing fish meat having fresh color

(76) Inventor: Po-Hsing Lee, Taipei City (TW)

Correspondence Address: JACOBSON HOLMAN PLLC, 400 SEVENTH STREET N.W., SUITE 600, WASHINGTON, DC, 20004, US

(21) Appl. No.: 12/801,240

(22) Filed: May 28, 2010

Related U.S. Application Data
(63) Continuation-in-part of application No. 11/798,570, filed on May 15, 2007, now abandoned.

(51) Int. Cl. A23B 4/08; A23B 4/16

(52) U.S. Cl. 426/393

(57) ABSTRACT

A method of producing fish meat having fresh color includes: placing live fish in a state of unconsciousness by blocking the conduction of nerve pulses along a nervous system of the fish; bleeding the fish and cutting meat pieces from the fish while the fish is unconscious; sterilizing the meat pieces; placing the sterilized meat pieces in a nitrogen environment that is free of oxygen and carbon dioxide, followed by quick freezing to a temperature below −30° C. in order to fix the original color of the meat pieces; and packaging the frozen meat pieces in a packing bag.

### CROSS REFERENCE TO RELATED APPLICATION

This application is a C-I-P application of U.S. patent application Ser. No. 11/798,570 filed on May 15, 2007.

### BACKGROUND OF THE INVENTION

1. Field of the Invention

The invention relates to a method of preserving fish, more particularly to a method of producing fish meat having fresh color.

2. Description of the Related Art

In general, fish meat tissues are vulnerable to bacterial decomposition. The meat of freshly caught fish is likely to decay under room temperature, and fats of fish are prone to oxidization and acidification, so that the color of fish is adversely affected. To preserve the fresh color of fish, fish have to be processed quickly after they are caught.

Referring to FIG. 1, a conventional method of preserving fresh color of fish is shown to include a cleansing step 10, a cutting step 11, a color enhancing step 12, a disinfecting step 13, an ozone sterilization step 14, a grading step 15, an ultraviolet sterilization step 16, a vacuum packaging step 17, a quick-freezing step 18, and a packaging and freezing step 19.

In the cleansing step 10, a live fish to be processed is moved to a fish tank containing clean water, and is kept there for at least 12 hours to allow the fish to discharge most of the excremental wastes in its body into the fish tank.

In the cutting step 11, the cleansed live fish is immersed in a solution containing sodium hypochlorite or chlorite for about 10 minutes so as to disinfect the surface of the fish. The fish is then washed in clean water to remove the sodium hypochlorite or chlorite therefrom. Then, the fish is killed instantly by cutting the throat of the fish using a knife, or by subjecting the fish to carbon monoxide. Thereafter, the fish is bled and filleted, the fish skin and the spine are removed, and edges of the meat pieces are trimmed to obtain a neat appearance.

In the color enhancing step 12, the meat pieces are placed in a gas-tight bag, and carbon monoxide gas is introduced into the bag for a period of time. For a meat piece of 200 g, the meat piece is placed in an environment of carbon monoxide for 40-60 minutes to allow the meat pigment myoglobin in the fish meat to react with the carbon monoxide so as to produce a bright pink or red color in the fish meat.

In the disinfecting step 13, the color enhanced meat pieces are immersed in a solution containing sodium hypochlorite or chlorite for about 1 minute. Then, the meat pieces are washed in clean water to remove residual sodium hypochlorite or chlorite so as to achieve surface disinfection. Since the color enhancing step 12 takes a relatively long time to conduct, bacteria may breed on the surface of the meat pieces. Therefore, the disinfecting step 13 is mainly intended to destroy the bacteria that breed during the color enhancing step 12.

In the ozone sterilizing step 14, the meat pieces are immersed in a sterilizing tank containing ozone (O₃) for sometime for sterilization. Thereafter, the meat pieces are removed and wiped dry.

In the grading step 15, the meat pieces are graded by weight so as to facilitate determination of the time required for subsequent freezing and packaging processing.

In the ultraviolet sterilizing step 16, the meat pieces are subjected to ultraviolet irradiation for sterilization purposes. This step is performed to kill bacteria that may breed on the meat pieces during the grading step 15 so as to prolong the shelf life of the meat pieces.

In the vacuum packaging step 17, the meat pieces thus sterilized are packed into packaging bags, and air within the packaging bags is evacuated to form a vacuum therein.

In the quick-freezing step 18, the packaging bags with the meat pieces are placed in a freezer at a temperature lower than −30° C. to quick-freeze the meat pieces.

In the packaging and freezing step 19, the frozen meat pieces are packed in Styrofoam® containers and stored in a freezer.

For a meat piece of 200 g, the time required for performing step 11 through step 13 is about 60-80 minutes, the time required for performing step 14 through step 17 is about 30-40 minutes, and the time required for performing steps 18 and 19 is about 90-100 minutes, adding up to a total of at least 3 hours.

It is apparent from the foregoing that the conventional method of preserving fresh color of fish has several disadvantages:

1. Prolonged processing time affects freshness of fish meat: To allow the myoglobin in fish meat to sufficiently react with carbon monoxide, the color enhancing step 12 generally takes at least 40 minutes to complete. For bigger or thicker meat pieces, the time will be longer. Therefore, the disinfecting step 13 is necessary to kill the bacteria generated during the color enhancing step 12. In so doing, the texture of the fish meat is also affected adversely, thereby reducing freshness of the fish meat and increasing the likelihood of food poisoning.

2. Potential health hazard: As the meat pieces show a bright pink or red color after being subjected to the carbon monoxide color enhancing treatment, the natural color of the fish meat is masked. Thus, consumers are unable to judge the freshness of the meat pieces by their appearance or color, and may unknowingly consume spoiled or toxic fish meat that threatens health.

3. Fish protein is likely to degrade, and bleeding is incomplete: As the live fish is instantly killed in the cutting step 11, the protein in the fish starts to degrade at the instant the fish is dead. Degraded protein generates toxic histamine that may endanger consumer's health when ingested. In addition, as the fish is instantly put to death and its nervous system virtually stops functioning, bleeding of the fish cannot be thoroughly done.

4. Packaged meat pieces tend to be compressed to result in impaired appearance: As the meat pieces are packaged in vacuum bags in the vacuum packaging step 17, the meat pieces may be compressed by the packaging bag so that residual blood in the capillaries on the surface of the meat pieces is forced out, which gradually becomes dark in color and mars the appearance of the packaged meat pieces.

In Bykowski et al., “Freshwater Fish Processing and Equipment in Small Plants”, 1996, FAO Fisheries Circular, C905, page 59+, a modified atmosphere packing system is disclosed for packing fresh fish. The system utilizes a gas mixture consisting of 30% nitrogen, 40% carbon dioxide and 30% oxygen. In the case of fat fish, the oxygen is replaced by nitrogen. The products of the modified atmosphere packing system are stored at the temperatures below 3° C.

However, although oxygen permits the fish heme to flow and hence maintains the red color of the fresh fish, it can oxidize fish when the fish is stored for a long period. On the other hand, although carbon dioxide can retard bacterial spoilage of fish, it can be dissolved in water on the fish, thus acidifying the fish and producing a deep brown color.

### SUMMARY OF THE INVENTION

Therefore, an object of the present invention is to provide a method of producing fish meat having fresh color so as to retard degradation of fish protein, shorten processing time, and retain the fresh color of fish meat for a relatively long period of time.

Accordingly, a method of producing fish meat having fresh color, comprises: placing live fish in a state of unconsciousness by blocking the conduction of nerve pulses along a nervous system of the fish; bleeding the fish and cutting meat pieces from the fish while the fish is unconscious; sterilizing the meat pieces; placing the sterilized meat pieces in a gas-tight bag, followed by vacuuming the gas-tight bag, introducing nitrogen into the vacuumed gas-tight bag and sealing the gas-tight bag containing nitrogen and the meat pieces so that the meat pieces are placed in a nitrogen environment that is free of oxygen and carbon dioxide; quick-freezing the gas-tight bag with the nitrogen environment to a temperature below −30° C. immediately after the gas-tight bag is sealed in order to fix the original color of the meat pieces; and placing the meat pieces in a packaging bag that is vacuumed partially and that contains air.

### BRIEF DESCRIPTION OF THE DRAWINGS

Other features and advantages of the present invention will become apparent in the following detailed description of the preferred embodiment with reference to the accompanying drawings, of which:

FIG. 1 is a flowchart to illustrate a conventional method of preserving fresh color of fish; and

FIG. 2 is a flowchart to illustrate the preferred embodiment of a method of producing fish meat having fresh color according to the present invention.

### DETAILED DESCRIPTION OF THE PREFERRED EMBODIMENT

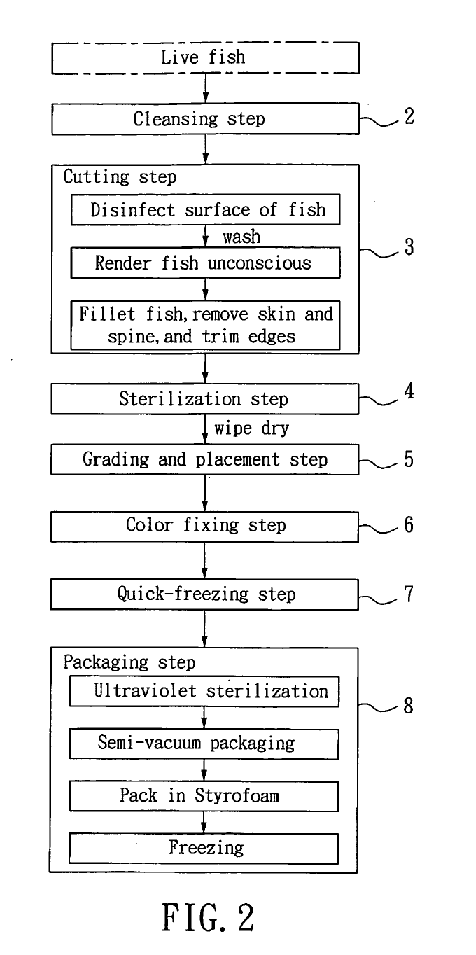

Referring to FIG. 2, the preferred embodiment of a method of producing fish meat having fresh color according to the present invention is shown to include a cleansing step 2, a cutting step 3, a sterilizing step 4, a grading and placement step 5, a color fixing step 6, a quick-freezing step 7, and a packaging step 8.

In the cleansing step 2, a live fish to be processed is moved to a fish tank containing clean water, and is kept there for at least 12 hours to allow the fish to discharge most of the excremental wastes in its body into the fish tank.

In the cutting step 3, the cleansed live fish is first subjected to a surface disinfecting treatment by immersing the live fish in a solution containing sodium hypochlorite or chlorite so as to disinfect the surface of the fish. Sodium hypochlorite is commonly referred to as a bleaching agent, which can destroy protein of microorganisms to thereby kill bacteria, fungi and viruses. Chlorite is a highly effective oxidizing agent, which can adhere to and penetrate cell walls of microorganisms to oxidize mercapto-containing enzymes therein to thereby destroy the same. The live fish is removed from the solution after about 10 minutes, and is washed in clean water to remove residual sodium hypochlorite and chlorite therefrom.

Thereafter, a pointed rod is used to sever or destroy nerves in the spine or spinal column of the fish so as to block the conduction of nerve pulses along the nervous system of the fish, thereby placing the live fish in a state of unconsciousness such that the fish is unable to struggle. At this point, the fish can be subjected to bleeding and cutting or filleting. Since the fish is merely unconscious and is still alive, the fish muscles will still twitch, and the fish can be bled substantially thoroughly so that the fish meat is comparatively whiter or clearer in appearance. Alternatively, the live fish can be rendered unconscious by putting the fish temporarily in an environment such that the fish suffers from oxygen deficiency and the conduction of nerves pulses is blocked. In an example, a lot of fish is put into a bucket of cold water with a temperature of about 5° C. Due to coldness of the water, the respiratory system of the fish gradually fails so that the fish suffers from deficiency of oxygen and becomes unconscious. When the fish no longer wriggles, the fish can be subjected to bleeding and filleting. During filleting, the fish is skinned, the spine is removed, and meat pieces are cut from the fish. Thereafter, edges of the meat pieces are trimmed to obtain a neat appearance.

In the sterilizing step 4, the meat pieces are immersed in a low-temperature ozone sterilizing tank at a temperature within a range from 0° C. to 5° C. for sterilization for 30 seconds. Thereafter, the meat pieces are removed and wiped dry.

In the grading and placement step 5, the meat pieces are graded according to the weight thereof. The purpose of grading the meat pieces is to determine the time needed for freezing the meat pieces and the packaging operation. The heavier the meat pieces, the longer the time required to freeze the meat pieces. Thereafter, a plurality of meat pieces of the same grade are arranged on a tray, and the tray with the meat pieces is placed in a sealable gas-tight bag. The meat pieces should be arranged in such a manner that they do not overlap so that the meat pieces will not stick together upon freezing.

In the color fixing step 6, the meat pieces are placed in a gas-tight bag that is free of oxygen and carbon dioxide. In the preferred embodiment, the gas-tight bag is vacuumed substantially completely, nitrogen is introduced into the gas-tight bag which is vacuumed, and the gas-tight bag is sealed after the nitrogen is introduced. The quick-freezing step 7 is conducted immediately after the gas-tight bag is sealed. In the quick-freezing step 7, the packaged meat pieces are placed in a freezer at a temperature below −30° C. so as to quick-freeze the meat pieces to thereby ensure freshness. Preferably, the meat pieces are frozen to a temperature below −35° C. in order to inhibit growth of anaerobic germs, such as clostridium botulinum and hence prolong the storage life of the meat pieces.

It is noted that the color fixing step 6 and the quick-freezing step 7 can be implemented in an assembly line having a conveyor belt. That is, trays with properly arranged meat pieces are placed on a conveyor belt to be transported to a cavity filled with nitrogen so as to expel the air in the gas-tight bags, and are further transported to the freezer for quick freezing. Thus, automated processing can be achieved to save manpower resources and operational time.

In the packaging step 8, the frozen meat pieces are subjected to ultraviolet sterilization for 80˜100 seconds. Thereafter, the frozen meat pieces are packed into a packaging bag, and air in the packaging bag is evacuated such that the volume of the packaging bag is reduced to 5% to 15% of an original volume of the packaging bag, thereby achieving a semi-vacuum state. Preferably, the volume of the packaging bag is reduced to about 10% of the original volume of the packaging bag. Thereafter, the packaging bag containing the meat pieces is placed in a Styrofoam® box for subsequent freezing. The purpose of leaving a small amount of air in the packaging bag is to prevent the packaging bag from adhering to and compressing the meat pieces. With the presence of a small amount of air in the packaging bag, the surface of the meat pieces can be kept intact. Certainly, nitrogen or an inert gas can be introduced into the packaging bag in place of air so as to provide a substantially oxygen-free environment.

With the present invention, for a fish meat piece of 200 g, the time needed to perform steps 3, 4 and 5 is about 20˜30 minutes. Filling the gas-tight bag with nitrogen in the color fixing step 6 takes only about several seconds, and steps 7 and 8 require about 90˜100 minutes to perform. Therefore, processing of a meat piece of 200 g can be completed in about 2 hours.

It is apparent from the foregoing that the present invention provides several advantages over the prior art in actual practice.

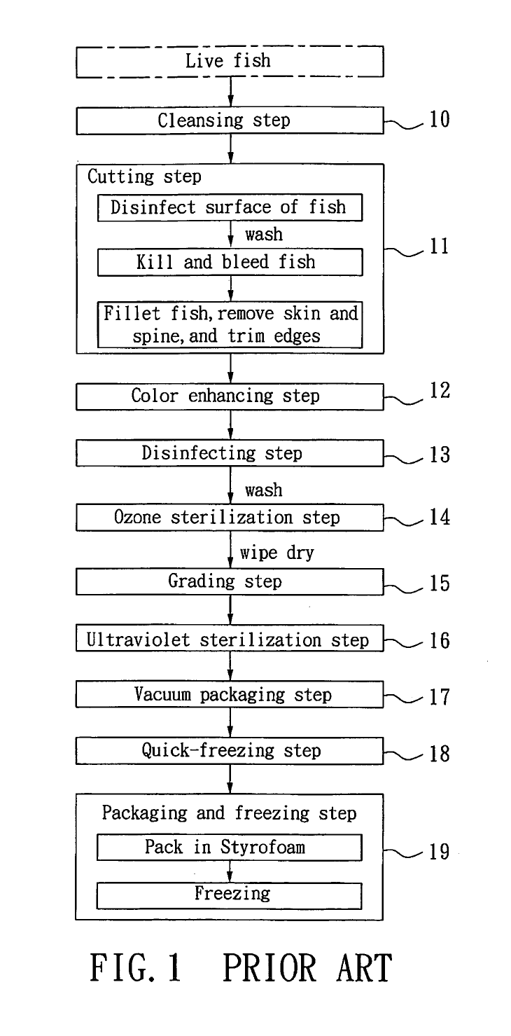

1. The processing time can be reduced considerably to ensure the freshness of fish meat: Since the nitrogen treatment can be completed in just several seconds, the fish meat can be isolated from ambient air so that the natural white or pink color of the fish meat can be maintained, which is very different from the prior art which utilizes carbon monoxide as a color enhancing agent and which requires a period of reaction time of about 40˜60 minutes to allow the carbon monoxide to exert its full effect. Besides, in the prior art, the time required for carbon monoxide to react will increase with an increase in the weight of the fish meat. Furthermore, as the color fixing step 6 in the present invention is extremely short, the fish meat can be directly subjected to quick-freezing without going through a disinfecting step, which is required in the prior art. In other words, the disinfecting step 13 (see FIG. 1) of the aforesaid prior art can be eliminated, thereby shortening the processing time and ensuring freshness of the fish meat.

2. Spoilage of the fish meat can be easily identified to ensure food safety: The color fixing step 6 employs the gas-tight bag which is free of carbon dioxide, and oxygen. Carbon dioxide cannot fix the fresh color of the fish because it can acidify the fish and produce brown color. Although oxygen can prevent a change in color of the fish, it can maintain the color only within a limited period because oxygen tends to oxidize and decompose the fish protein. Furthermore, the color fixing step 6 does not utilize carbon monoxide, which is used in the prior art illustrated in FIG. 1. Carbon monoxide can create a bright red color in the fish to mask the natural color of the fish meat. Thus, it is not safe to use carbon monoxide because consumers can not correctly identify the fresh color of the fish meat through the naked eye when carbon monoxide is used. In the present invention, nitrogen is introduced into the vacuumed gas-tight bag that is free of oxygen and carbon dioxide in order to fix the fresh color of the meat pieces. Because the gas-tight bag does not contain oxygen and carbon dioxide that can affect adversely the fresh color of the fish, and because the gas-tight bag is vacuumed and filled with nitrogen that is inert, natural white or pink color of the fish meat can be maintained for a relatively long period of time. Thus, consumers can readily identify the freshness of the fish meat by looking, and can avoid eating spoiled fish meat, or fish meat that starts to develop toxics.

3. The natural white or pink color of the fish meat can be retained for a relatively long period of time while delaying degradation of fish protein: Since the live fish is bled and filleted after being rendered unconscious in step 2, bleeding can be done substantially thoroughly to help retain the original white or pink color of the fish meat. Besides, since death of the fish is delayed, degradation of the fish protein can be retarded as well. Furthermore, because the quick freezing step 7 that immediately follows the color fixing step 6 is conducted at a temperature below −30° C., the temperature of the inside part of the fish can be lowered up to −20° C., and the surface temperature of the fish can be −30° C. As such, the water, cell wall and the heme of the fish can be solidified completely and can be prevented from flowing and being denatured. The freshness of the fish can therefore be maintained. In addition, because the nitrogen environment used in the color fixing step is free of oxygen and carbon dioxide, growth of aerobic germs can be retarded due to lack of oxygen, and acidification of the fish does not occur due to lack of carbon dioxide and due to the presence of nitrogen that is inert. Moreover, because the quick-freezing step is conducted below −30° C. immediately after the color fixing step, growth of anaerobic germs, such as clostridium botulinum can also be retarded. Therefore, the fish can be stored for a long period up to several months.

4. The appearance of the fish meat will not be adversely affected by packaging: Since a small amount of air is retained in the packaging bag in step 8, the packaging bag will not adhere to the fish meat to compress the capillaries on the surface of the fish meat, thereby preserving the surface of the fish meat intact.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method of producing fish meat having fresh color, comprising:
placing live fish in a state of unconsciousness by blocking the conduction of nerve pulses along a nervous system of the fish;
bleeding the fish and cutting meat pieces from the fish while the fish is unconscious;
sterilizing the meat pieces;
placing the sterilized meat pieces in a gas-tight bag, followed by vacuuming the gas-tight bag, introducing nitrogen into the vacuumed gas-tight bag and sealing the gas-tight bag containing nitrogen and the meat pieces so that the meat pieces are placed in a nitrogen environment that is free of oxygen and carbon dioxide;
quick-freezing the gas-tight bag with the nitrogen environment to a temperature below −30° C. immediately after the gas-tight bag is sealed, thereby fixing the original color of the meat pieces; and
placing the meat pieces in a packaging bag that is vacuumed partially and that contains air.

2. The method according to claim 1, wherein, the live fish is placed in the state of unconsciousness using a pointed rod to sever nerves in the spine of the fish such that the fish is unable to struggle.

3. The method according to claim 1, wherein the live fish is placed in the state of unconsciousness by causing the fish to suffer from oxygen deficiency such that the fish is unable to struggle.

4. The method according to claim 1, wherein, before placing the live fish in the state of unconsciousness, the live fish is subjected to a surface disinfecting treatment.

5. The method according to claim 4, wherein the live fish is subjected to the surface disinfecting treatment by immersing the fish in a solution containing sodium hypochlorite or chlorite.

6. The method according to claim 1, wherein, in the sterilizing step, the meat pieces are disposed in a low-temperature ozone sterilization tank at a temperature of 0° C. to 5° C.

7. The method according to claim 1, further comprising a step of grading the meat pieces according to weight of the meat pieces, arranging the meat pieces on a tray, and placing the tray with the meat pieces in the gas-tight bag.

8. The method according to claim 1, wherein, in the step of packaging, the meat pieces are subjected to ultraviolet sterilization before being packed into the packaging bag.

9. The method according to claim 8, wherein, in the step of packing, the packaging bag is vacuumed such that the volume of the packaging bag is reduced to 5%˜15% of an original volume of the packaging bag.

10. The method according to claim 9, wherein the volume of the packaging bag is reduced to 10% of the original volume of the packaging bag.

11. The method according to claim 10, wherein the packaging bag together with the meat pieces therein is put into a Styrofoam box for subsequent freezing.
